(19) United States
(12) Patent Application Publication
(10) Pub. No.: US 2013/0315442 A1
(43) Pub. Date: Nov. 28, 2013

(54) OBJECT DETECTING APPARATUS AND OBJECT DETECTING METHOD

(71) Applicant: KABUSHIKI KAISHA TOSHIBA, Tokyo (JP)

(72) Inventors: Tsuyoshi TASAKI, Kanagawa (JP); Daisuke YAMAMOTO, Kanagawa (JP); Yuka KOBAYASHI, Aichi (JP)

(73) Assignee: Kabushiki Kaisha Toshiba, Tokyo (JP)

(21) Appl. No.: 13/850,499

(22) Filed: Mar. 26, 2013

(30) Foreign Application Priority Data
May 25, 2012 (JP) 2012-120105

(51) Int. Cl. G06K 9/00

(52) U.S. Cl. CPC G06K 9/00536
USPC 382/103

(57) ABSTRACT

According to an embodiment, an object detecting apparatus includes an image acquiring unit and a determining unit. The image acquiring unit is configured to acquire a target image within a second range included in a first range. The determining unit is configured to determine whether an object not captured in a reference image captured by the image capturing unit while the image capturing unit moves within the first range is captured in the target image, on the basis of a difference between each frequency of pixel values in a histogram for a first region and each frequency of pixel values in a second region of the target image corresponding to the first region, the first region being one of regions each extending in a direction of blurring caused by movement.

### CROSS-REFERENCE TO RELATED APPLICATION

This application is based upon and claims the benefit of priority from Japanese Patent Application No. 2012-120105, filed on May 25, 2012; the entire contents of which are incorporated herein by reference.

### FIELD

Embodiments described herein relate generally to an object detecting apparatus, an object detecting method and a computer program product.

### BACKGROUND

Various technologies for detecting an object from an image captured by a camera are known. It is also known to connect a camera that takes images and a processing device that performs processing for detecting an object via a network.

It is, however, difficult to detect whether or not an object is present from a blurred image captured while the camera moves.

### BRIEF DESCRIPTION OF THE DRAWINGS

FIG. 1 is a diagram illustrating an object detecting apparatus according to an embodiment;

FIG. 2 illustrates examples of images captured by an image capturing unit according to the embodiment;

FIGS. 3A and 3B are schematic diagrams illustrating a process of generating a histogram according to the embodiment;

FIGS. 4A and 4B illustrate an example of an image formed in the process of generating a histogram and an example of a histogram group image according to the embodiment;

FIG. 5 is a histogram generated for a first region by the histogram generating unit according to the embodiment;

FIG. 6 is a flowchart illustrating an exemplary operation of the object detecting apparatus according to the embodiment;

FIGS. 7A and 7B illustrate an image for detection in which an object is not present and an image representing a determination result (absence of object) from a determining unit according to the embodiment;

FIGS. 8A and 8B illustrate an image for detection in which an object is present and an image representing a determination result (presence of object) from the determining unit according to the embodiment;

FIG. 9 is a schematic diagram illustrating a state in which a histogram generating unit has generated a plurality of histograms according to a modification;

FIG. 10 is a schematic diagram illustrating a process of determining a position at which a captured image range is divided according to the modification; and

FIGS. 11A and 11B illustrate images and images representing the numbers of object candidate pixels of the respective images according to the modification.

### DETAILED DESCRIPTION

According to an embodiment, an object detecting apparatus includes an image acquiring unit and a determining unit. The image acquiring unit is configured to acquire at least one target image for detection, the target image being captured by an image capturing unit while the image capturing unit moves within a second image capturing range included in a predetermined first image capturing range. The determining unit is configured to determine whether or not an object that is not captured in at least one reference image is captured in the target image, on the basis of a difference between each frequency of pixel values in a histogram for a first region and each frequency of pixel values in a second region of the target image corresponding to the first region, the first region being one of a plurality of regions each extending in a direction of blurring caused by movement of the image capturing unit in the reference image, the reference image being captured by the image capturing unit while the image capturing unit moves within the first image capturing range.

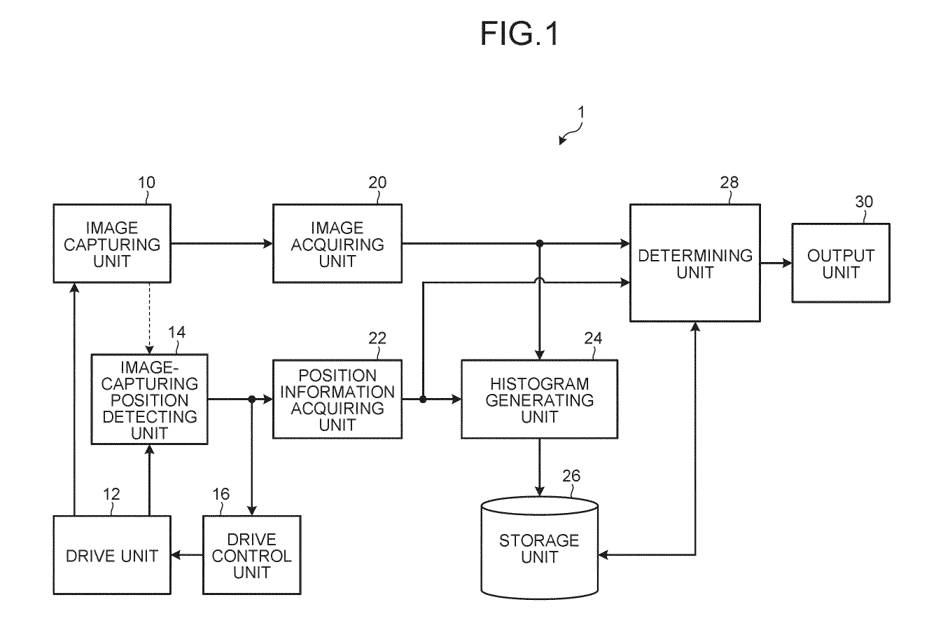

Embodiments of an object detecting apparatus will be described in detail below with reference to the accompanying drawings. FIG. 1 is a configuration diagram illustrating a configuration of an object detecting apparatus 1 according to an embodiment. As illustrated in FIG. 1, the object detecting apparatus 1 includes an image capturing unit 10, a drive unit 12, an image-capturing position detecting unit 14, a drive control unit 16, an image acquiring unit 20, a position information acquiring unit 22, a histogram generating unit 24, a storage unit 26, a determining unit 28 and an output unit 30, for example.

The image capturing unit 10 is a digital camera or the like that has a solid-state image sensor such as a charge coupled device (CCD) and a lens (not illustrated), takes a plurality of images at predetermined time intervals and outputs the captured images to the image acquiring unit 20. For example, the image capturing unit 10 captures reference images and target images for detection, which will be described later. The image capturing unit 10 may be configured to take an image at an arbitrarily set time or may be a moving image imaging device that captures images of a plurality of frames within a predetermined time. Thus, the images captured by the image capturing unit 10 may not include or may include images of regions that overlap with one another.

The drive unit 12 drives the image capturing unit 10 so that the image capturing unit 10 can move in a first image capturing range, which will be described later, for imaging. Note that the drive unit 12 moves the image capturing unit 10 during exposure during which the image capturing unit 10 emits light to the solid-state image sensor or the like via the lens. Specifically, since the movement of the image capturing unit 10 is greater as compared to the shutter speed of the image capturing unit 10, an image captured by the image capturing unit 10 results in a blurred image according to the movement of the image capturing unit 10. In addition, when the image capturing unit 10 performs image capturing in a dark place, images are more likely to be faint as blurred images even the movement of the image capturing unit 10 is small as compared to a case in which image capturing is performed in bright light.

The image-capturing position detecting unit 14 detects position information representing each image-capturing position of the image capturing unit 10 and outputs the detected image information to the drive control unit 16 and the position information acquiring unit 22. For example, the image-capturing position detecting unit 14 is implemented by an encoder provided in the drive unit 12. Alternatively, the image-capturing position detecting unit 14 may be implemented by an acceleration sensor provided in the image capturing unit 10.

The drive control unit 16 receives the position information detected by the image-capturing position detecting unit 14 and controls the drive unit 12 so that the image capturing unit 10 moves within a predetermined range. For example, the drive control unit 16 controls the drive unit 12 so that an image-capturing position of a reference image and an image-capturing position of an image for detection will correspond to each other on the basis of the position information detected by the image-capturing position detecting unit 14.

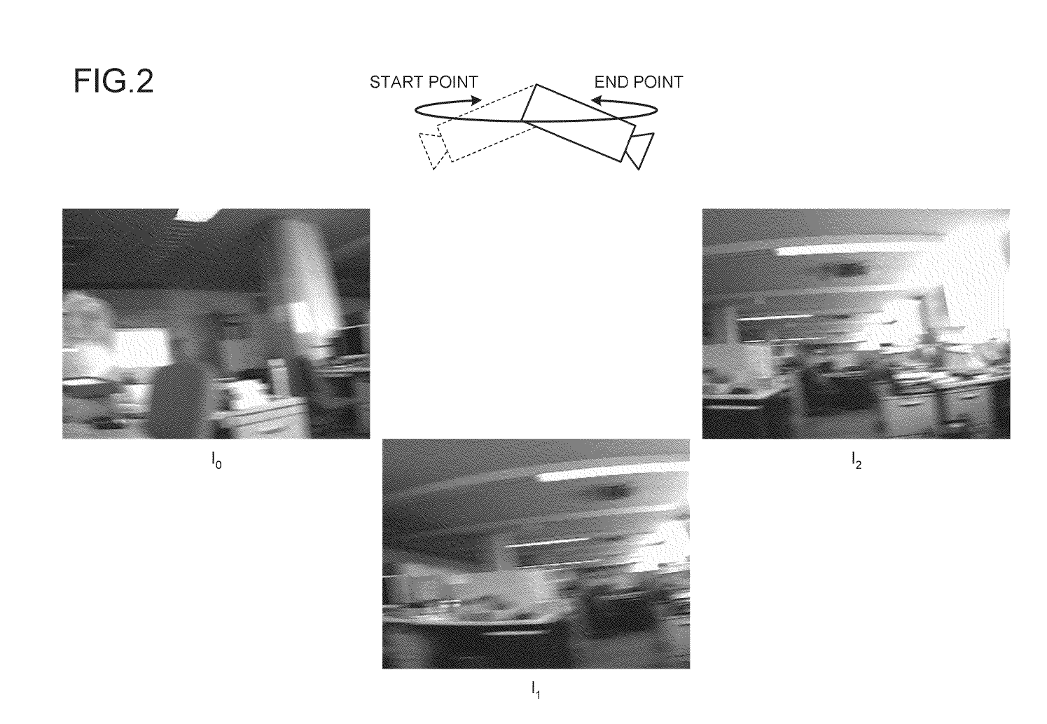

FIG. 2 illustrates examples of images captured by the image capturing unit 10 moving according to control by the drive control unit 16. The image capturing unit 10 moves on a horizontal circle from a start point to an end point illustrated in FIG. 2 around a virtual axis of rotation, which is not illustrated, extending in the vertical direction according to the control by the drive control unit 16, for example. The image capturing unit 10 moves periodically in a reciprocating manner from the start point to the end point, for example. The drive control unit 16 may be configured to calculate autocorrelation of the position information detected by the image-capturing position detecting unit 14 so as to determine the start point and the end point of the periodic motion of the image capturing unit 10.

For example, the image capturing unit 10 captures images I₀, I₁ and I₂ while moving from the start point to the end point. Note that each of images (the images I₀, I₁ and I₂, for example) that are captured by the image capturing unit 10 in a state in which it is clear that no object to be detected is present is used as a reference image (background image) in order to detect an object to be detected by the object detecting apparatus 1. Images that are captured by the image capturing unit 10 while the object detecting apparatus 1 is in operation when it is necessary to detect an object to be detected are images for detection that are distinguished from reference images. An object to be detected will hereinafter be simply abbreviated to an “object” in some cases.

Note that a range in which the image capturing unit 10 can capture images while the image capturing unit 10 moves from the start point to the end point is referred to as a first image capturing range for capturing reference images. In addition, the image capturing unit 10 is allowed to capture images within a second image capturing range for capturing target images for detection that is included in the first image capturing range. The first image capturing range and the second image capturing range may be identical. When the second image capturing range is included in the first image capturing range, the numbers of reference images and target images for detection may be one or more than one. The image capturing unit 10 captures a reference image when the object detecting apparatus 1 is initialized, when the image capturing unit 10 has received an instruction from outside that is not illustrated, or the like.

The image acquiring unit 20 (FIG. 1) acquires the images captured by the image capturing unit 10 and outputs the acquired images to the histogram generating unit 24 and the determining unit 28. The position information acquiring unit 22 acquires the position information detected by the image-capturing position detecting unit 14 and outputs the acquired position information to the histogram generating unit 24 and the determining unit 28.

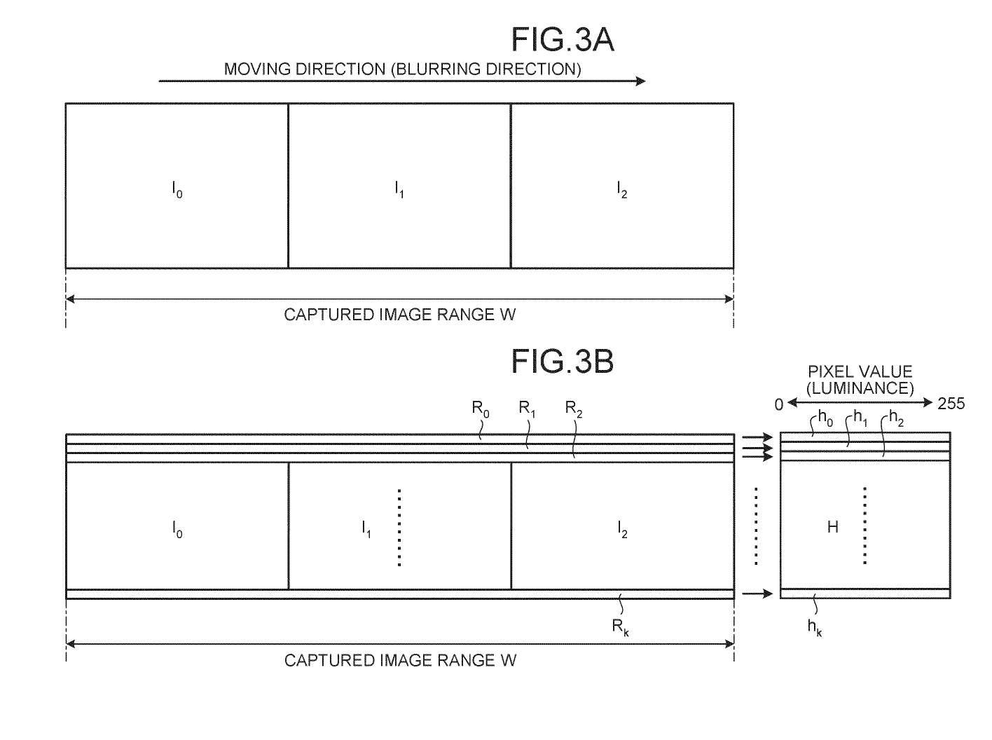

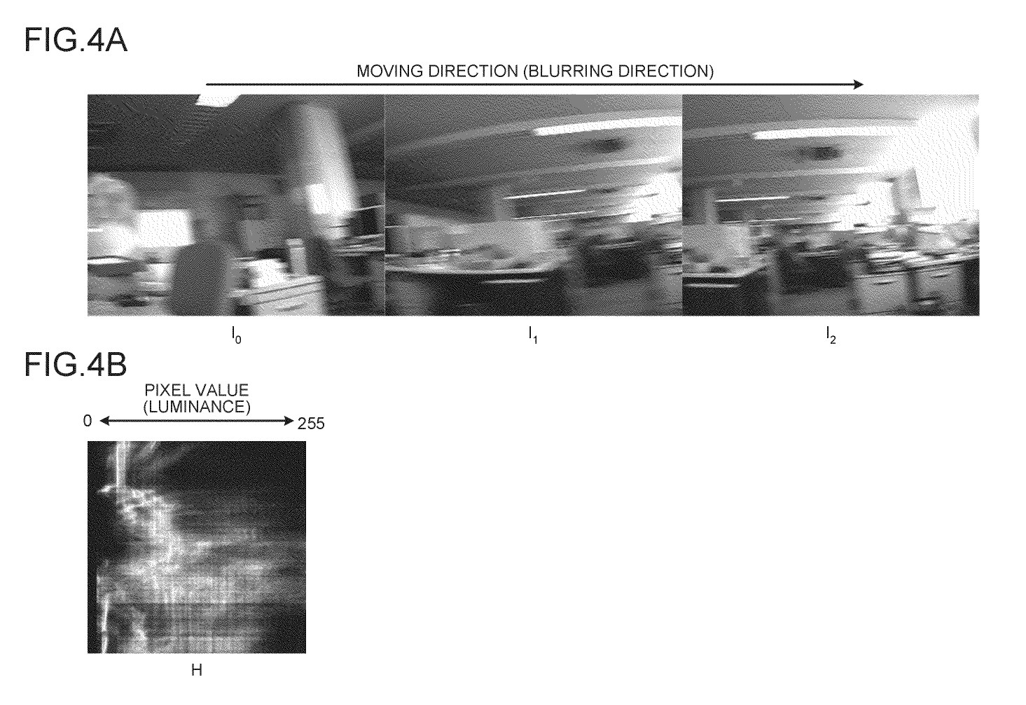

The histogram generating unit 24 generates a histogram representing distribution of frequency of each pixel value (luminance) for the images received from the image acquiring unit 20 and normalizes the histogram. FIGS. 3A and 3B are schematic diagrams schematically illustrating a process of generating a histogram by the histogram generating unit 24. FIGS. 4A and 4B illustrate an example of an image of a captured image range W formed in the process of generating the histogram illustrated in FIGS. 3A and 3B and an example of a histogram group image H. For example, the histogram generating unit 24 arranges the images I₀, I₁ and 1₂ captured by the image capturing unit 10 along the moving direction of the image capturing unit 10 as illustrated in FIGS. 3A and 4A. Thus, the images I₀, I₁ and 1₂ are arranged in time series in the direction of blurring of the images caused by the movement of the image capturing unit 10. The histogram generating unit 24 then regards the images I₀, I₁ and 1₂, for example, as one image of the captured image range W.

Subsequently, the histogram generating unit 24 divides the image of the captured image range W into a plurality of first regions (R₀ to Rₖ) each extending in the direction of blurring caused by the movement of the image capturing unit 10 and generates a histogram (h₀ to hₖ) of pixel values for each of the first regions as illustrated in FIG. 3B. The histograms (h₀ to hₖ) may be presented as a histogram group image H in which the horizontal direction represents an 8-bit pixel value (luminance), the vertical direction represents the number 0 to k of the subscripts of the first regions R₀ to Rₖ of the reference image and the frequency of pixel values is represented by an 8-bit density value as illustrated in FIGS. 3B and 4B. Note that parts with low frequency are illustrated in black and parts with high frequency are illustrated in white and brightly in FIG. 4B.

The histogram generating unit 24 also associates the generated histogram (and the reference images) and the position information received from the position information acquiring unit 22 so that the image-capturing positions and the histogram correspond to each other and outputs the association result to the storage unit 26.

The storage unit 26 receives and stores the associated histogram (and reference images) and position information from the histogram generating unit 24. The storage unit 26 may also be configured to store a determination result from the determining unit 28, which will be described later.

The determining unit 28 receives the images captured by the image capturing unit 10 via the image acquiring unit 20 and receives the position information detected by the image-capturing position detecting unit 14 via the position information acquiring unit 22. The determining unit 28 also acquires the associated histogram and position information and the like from the storage unit 26. The determining unit 28 then determines whether an object (an object to be detected) that is not imaged in the reference images but is imaged in the target images for detection is present or not and outputs the determination result to the output unit 30.

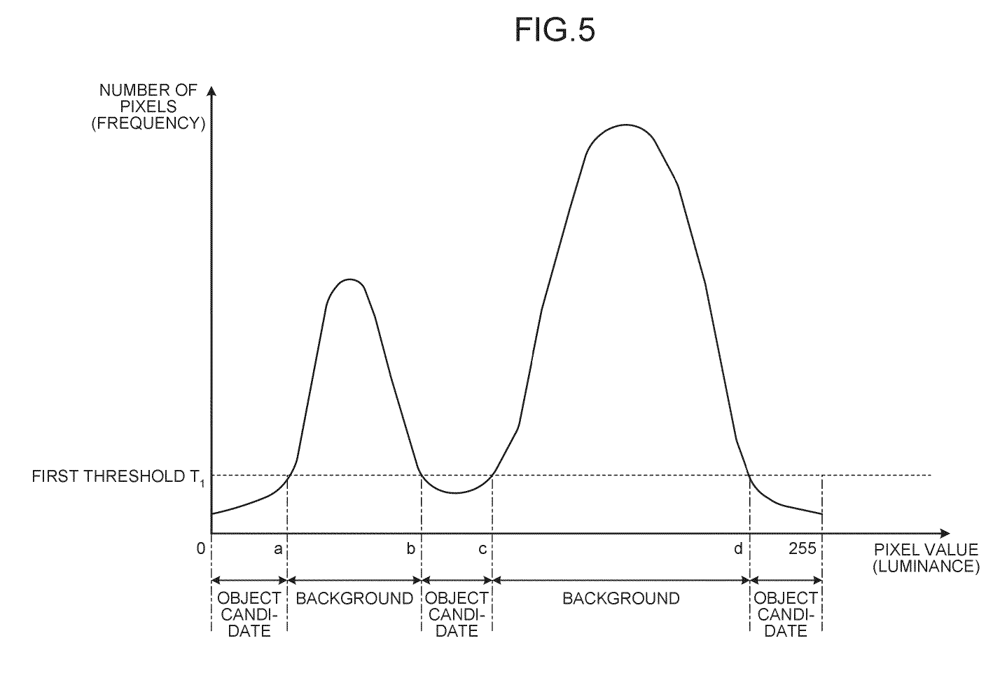

A method for determining whether or not the object to be detected is present by the determining unit 28 will be described here. FIG. 5 is a graph schematically illustrating a histogram generated for one first region (see FIGS. 3A and 3B) by the histogram generating unit 24. Since the reference images for which the histogram generating unit 24 generates a histogram are images captured by the image capturing unit 10 while the image capturing unit 10 is moving, pixels having the same pixel value (or pixel values that are close to one another) are arranged therein in the blurring direction according to the movement of the image capturing unit 10. Thus, the pixel values of the reference images have a tendency that the pixel values of each first region are likely to be the same specific pixel value (or pixel values close to a specific pixel value).

As illustrated in FIG. 5, the histogram has a first threshold T₁ set for the frequency. The first threshold T₁ is a threshold for determining whether pixels of a second region of a target image for detection are pixels representing a background (background image) or object candidate pixels (object candidate) that are a candidate of pixels representing the object to be detected for each pixel value on the basis of the frequency. The first threshold T₁ may be set for each first region. In addition, the first threshold T₁ is set in advance by a user according to conditions such as the size of the object the presence of which is to be determined and the determination accuracy.

The second region of an image for detection is a region on an image corresponding to the first region of a reference image. For example, in a case of a target image for detection that is captured at the same image-capturing position as a reference image and that has no object therein that is not present in the reference image, the reference image and the target image for detection are substantially identical or similar images and an image in each second region is substantially identical or similar to that in the corresponding first region.

Specifically, the determining unit 28 determines pixels of a second region having pixel values with the frequency being the first threshold T₁ or greater to be pixels representing a background, and determines pixels of a second region having pixel values with the frequency being smaller than the first threshold T₁ to be object candidate pixels. In the example illustrated in FIG. 5, the determining unit 28 determines pixels having pixel values equal to or larger than a and smaller than b and pixels having pixel values equal to or larger than c and smaller than d to be pixels representing a background and determines pixels having pixel values smaller than a, equal to or larger than b and smaller than c, and equal to or larger than d to be object candidate pixels. While an example of a case in which pixels in a second region having pixels values with the frequency being smaller than the first threshold T₁ are determined to be object candidate pixels in all the ranges of pixel values (0 to 255) is illustrated in FIG. 5, but the determination is not limited thereto. For example, pixels having pixel values that clearly cannot be object candidate pixels may be set not to be determined as object candidate pixels in advance.

The determining unit 28 determines whether pixels in each second region are pixels representing a background or object candidate pixels by comparison with a histogram of the corresponding first region. In other words, the determining unit 28 determines whether pixels are either pixels representing a background or object candidate pixels for all the pixels of an image for detection.

Furthermore, the determining unit 28 determines whether or not the frequency of pixels (the number N of object candidate pixels) of the target image for detection determined to be object candidate pixels is equal to or greater than the second threshold T₂. If the number N of object candidate pixels is greater than the second threshold T₂, the determining unit 28 determines that an object that is not imaged in the reference images but is imaged in the image for detection is present. Thus, if the number N of object candidate pixels is smaller than the second threshold T₂, the determining unit 28 determines that an object to be detected is not present. Note that the second threshold T₂ is set in advance by the user according to conditions such as the size of the object the presence of which is to be determined and the determination accuracy.

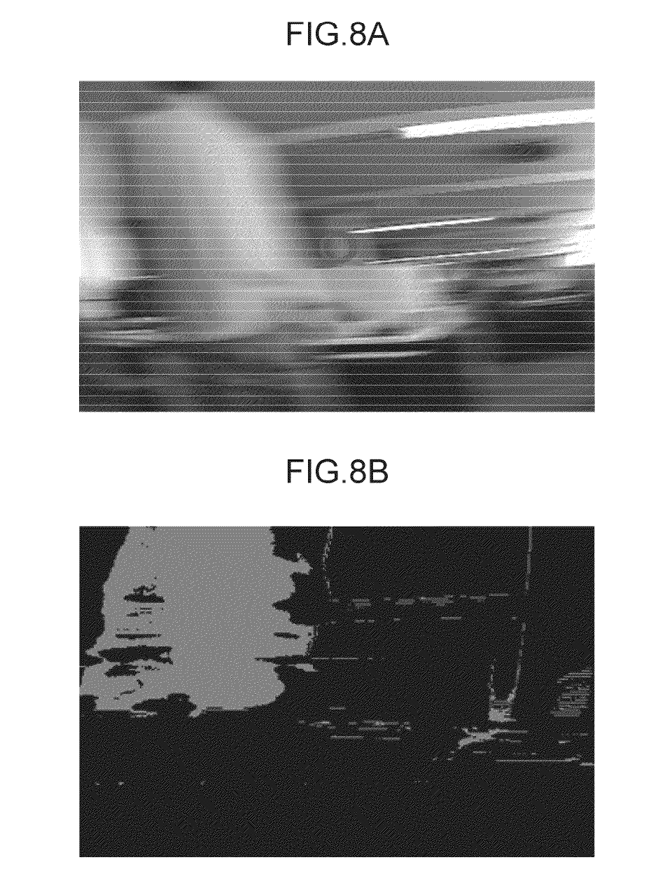

The output unit 30 receives and outputs the determination result of determination by the determining unit 28. For example, the output unit 30 is a display device and displays the determination result and the like, which will be described later with reference to FIGS. 8A and 8B.

Note that the configuration of the object detecting apparatus 1 is not limited to that illustrated in FIG. 1. For example, the object detecting apparatus 1 may be configured such that the image capturing unit 10, the drive unit 12, the image-capturing position detecting unit 14 and the drive control unit 16 are separately provided and the image acquiring unit 20 and the position information acquiring unit 22 acquires images and position information via a communication unit such as a wireless LAN.

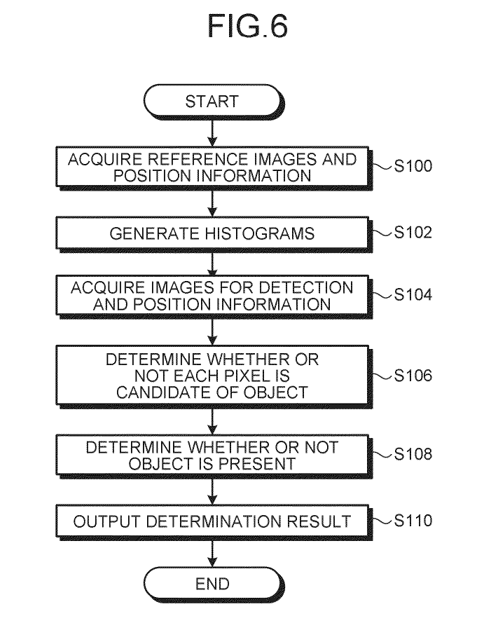

Next, an outline of exemplary operation of the object detecting apparatus 1 will be described. FIG. 6 is a flowchart illustrating the outline of exemplary operation of the object detecting apparatus 1. As illustrated in FIG. 6, in step S100, the object detecting apparatus 1 acquires one or more reference images and position information representing image-capturing positions of the reference images.

In step S102, the histogram generating unit 24 generates a histogram for each first region of the reference images acquired in step S100.

In step S104, the object detecting apparatus 1 acquires one or more images for detection and position information representing image-capturing positions of the images for detection.

In step S106, the determining unit 28 compares each histogram of the reference images with a pixel value of each pixel of the images for detection corresponding to the reference images to determine whether each pixel of the images for detection is a pixel representing a background or an object candidate pixel (whether or not each pixel is a candidate of the object to be detected). In this process, the determining unit 28 identifies an image for detection corresponding to a reference image by using the position information of the reference images and the position information of the images for detection. Thus, the position information of a reference image is preferably identical to the position information of an image for detection. The operation for detecting an object by the object detecting apparatus 1, however, is not limited to the case in which the position information of a reference image and the position information of a target image for detection are identical. For example, the object detecting apparatus 1 may detect whether or not the object described above is present in an image for detection by using a histogram generating from three reference images and one target image for detection whose position information is identical or substantially identical to that of any one of the reference images. Alternatively, the object detecting apparatus 1 may detect whether or not the object is present in an image for detection whose image-capturing position is slightly shifted from that of a reference image. In a case where the background does not change much regardless of the image-capturing position in the first image capturing range (the difference in the luminance distribution is small), the drive control unit 16 need not control the drive unit 12 so that the image-capturing position of a reference image and that of a target image for detection correspond to each other. In other words, the correspondence between the image-capturing position of a reference image and that of a target image for detection may be set by the user according to the accuracy of detection of the object or the like.

In step S108, the determining unit 28 determines whether or not an object that is not imaged in the reference images but is imaged in the target image for detection is present by using the second threshold T₂.

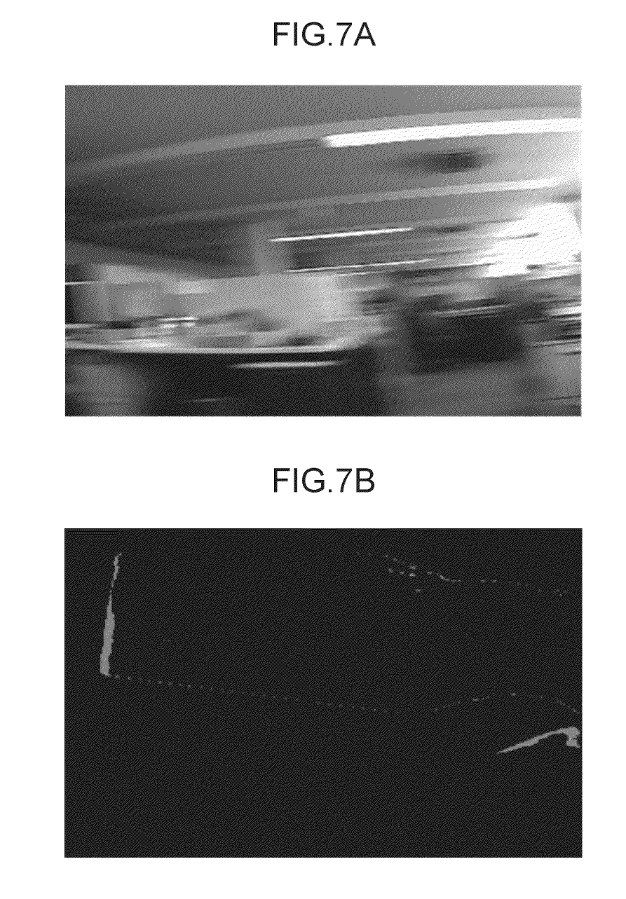

FIGS. 7A and 7B illustrate a target image for detection in which the object to be detected is not present and an image representing a result (absence of the object to be detected) of determination whether or not each pixel of the target image for detection is an object candidate made by the determining unit 28. FIGS. 8A and 8B illustrate a target image for detection (except a circle in the center) in which the object to be detected is present and an image representing a result (presence of the object to be detected) of determination whether or not each pixel of the target image for detection is an object candidate made by the determining unit 28. In FIGS. 7B and 8B, object candidate pixels and pixels that are not object candidate pixels (pixels representing the background) are distinguished from each other using different colors of pixels. Since pixels having pixel values with the frequency being smaller than the first threshold T₁ are present even if the object is not present in the target image for detection illustrated in FIG. 7A, a few pixels that are object candidate pixels (pixels represented in gray; pixels of low density not in black) are present as illustrated in FIG. 7A. If, however, the object is present in the target image for detection illustrated in FIG. 8A, the number N of object candidate pixels becomes greater (equal to or greater than the second threshold T₂) as illustrated in FIG. 8B.

In step S110, the output unit 30 receives and outputs the determination result of determination by the determining unit 28. For example, the output unit 30 may be configured to display a target image for detection in which it is determined that “the object is present” by the determining unit 28 with a circle in the center thereof as in FIG. 8A to clearly indicate that the object is present in the target image for detection. In addition, since the determining unit 28 determines whether each pixel of a target image for detection is a pixel representing the background or an object candidate pixel, the determining unit 28 also contributes to detection of the size of the object to be detected. A target image for detection is associated with position information. Accordingly, the object detecting apparatus 1 may be configured to output information regarding the size and the position of a detected object through the output unit 30.

Modifications

In the embodiment described above, the object detecting apparatus 1 generates a histogram by the histogram generating unit 24 by using all of the reference images (images I₀, I₁ and I₂, for example) captured within the first image capturing range. In a modification of the embodiment, the object detecting apparatus 1 divides the first image capturing range into a plurality of ranges and generates a histogram for each of the divided ranges by the histogram generating unit 24. Specifically, the histogram generating unit 24 divides a captured image range W including all the reference images and generates a plurality of histograms.

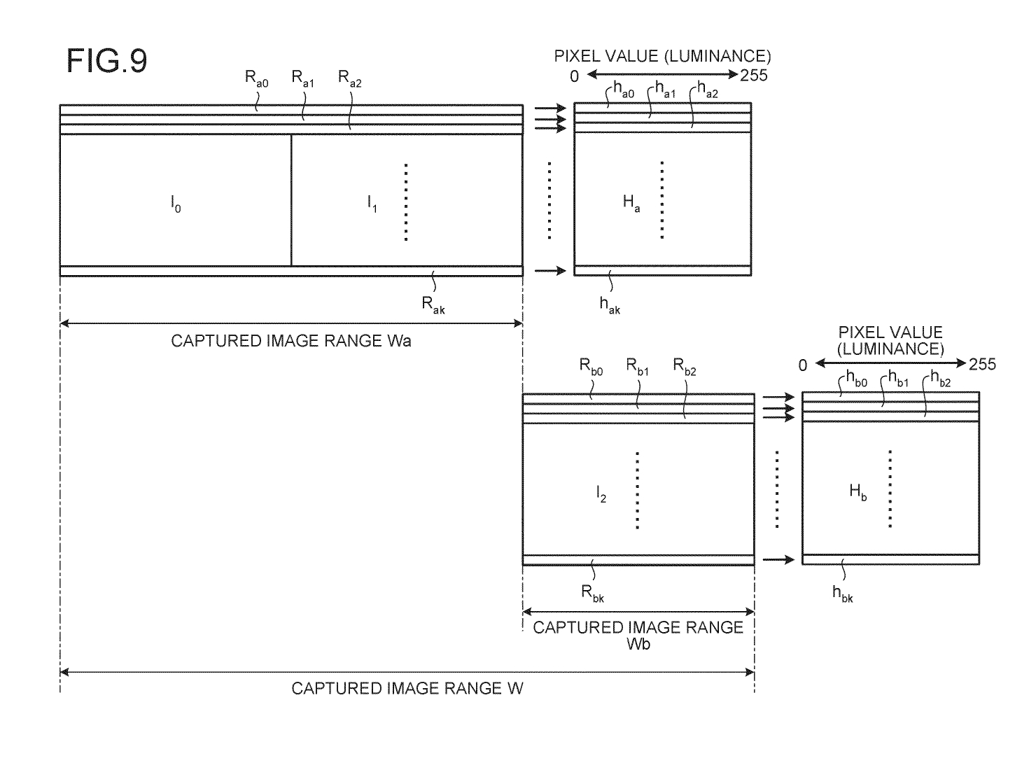

FIG. 9 is a schematic diagram schematically illustrating a state in which the histogram generating unit 24 according to the modification has divided the captured image range W and generated a plurality of histograms. As illustrated in FIG. 9, the histogram generating unit 24 divides the captured image range W including the images I₀, I₁ and I₂ into a captured image range Wa including the images I₀ and I₁ and a captured image range Wb including the image I₂, for example. The position at which the histogram generating unit 24 divides the captured image range W may be arbitrarily set or determined by a method described below.

Subsequently, the histogram generating unit 24 divides the image of the captured image range Wa into a plurality of first regions (Rₐ₀ to Rₐₖ) extending in the direction of blurring caused by the movement of the image capturing unit 10 and generates a histogram (hₐ₀ to hₐₖ) of pixel values for each of the first regions. The histograms (hₐ₀ to hₐₖ) may be presented as a histogram group image Hₐ in which the horizontal direction represents an 8-bit pixel value (luminance), the vertical direction represents the number 0 to k of the subscripts excluding the alphabets of the first regions of the reference image and the frequency of pixel values is represented by an 8-bit density value, for example.

The histogram generating unit 24 also divides the image of the captured image range Wb into a plurality of first regions (R_{b0} to R_{bk}) extending in the direction of blurring caused by the movement of the image capturing unit 10 and generates a histogram (h_{b0} to h_{bk}) of pixel values for each of the first regions. The histograms (h_{b0} to h_{bk}) may be presented as a histogram group image H_{b} in which the horizontal direction represents an 8-bit pixel value (luminance), the vertical direction represents the number 0 to k of the subscripts excluding the alphabets of the first regions of the reference image and the frequency of pixel values is represented by an 8-bit density value, for example.

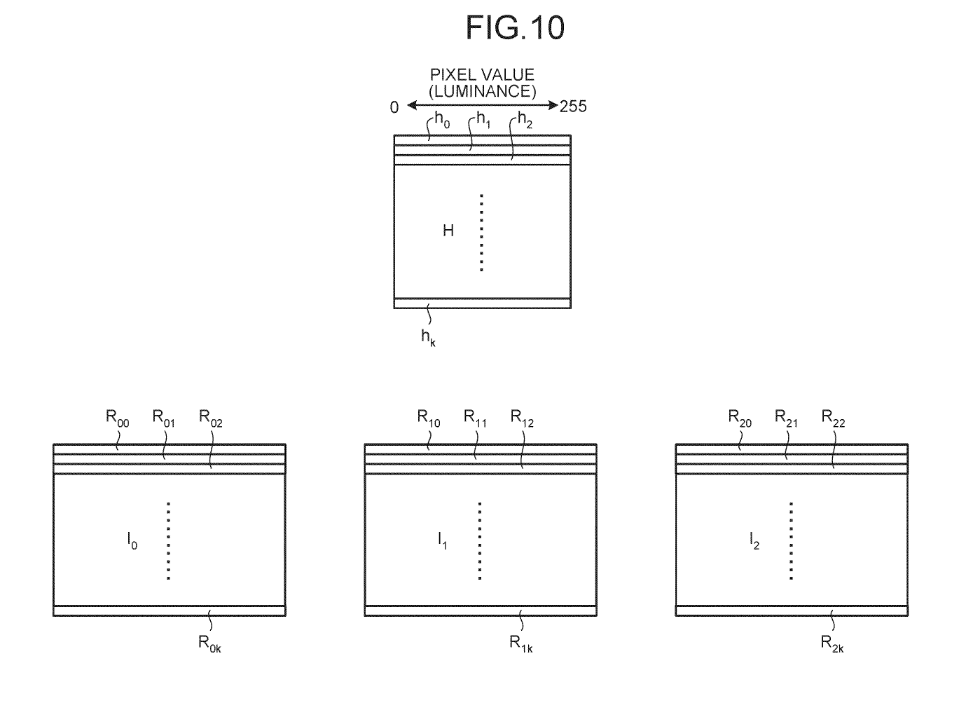

Next, a method for determining the position at which the histogram generating unit 24 divides the captured image range W will be described. FIG. 10 is a schematic diagram schematically illustrating a process of determining the position at which the histogram generating unit 24 according to the modification divides the captured image range W. In order to divide the histogram group image H generated by using all of the reference images (images I₀, I₁ and I₂) into a plurality of histogram group images as illustrated in FIG. 9, the histogram generating unit 24 first divides each of the images I₀, I₁ and I₂ into a plurality of first regions each extending in the direction of blurring caused by the movement of the image capturing unit 10. Here, an n-th first region from the top of an image Iₘ is referred to as Rₘₙ.

Next, the histogram generating unit 24 acquires target images for detection in a state in which no object to be detected is present at the same image-capturing positions as the images I₀, I₁ and I₂ and calculates the number Nₘ of the object candidate pixels. Note that Nₘ may be calculated by using the images I₀, I₁ and 1₂ themselves as target images for detection without performing imaging at the same image-capturing positions. The histogram generating unit 24 may also regard an image Iₘ (each of the images I₀, I₁ and I₂) as a target image for detection and compare each pixel of the first region (second region) of the image Iₘ with a corresponding histogram hₙ to calculate the number Nₘ of object candidate pixels of each image Iₘ.

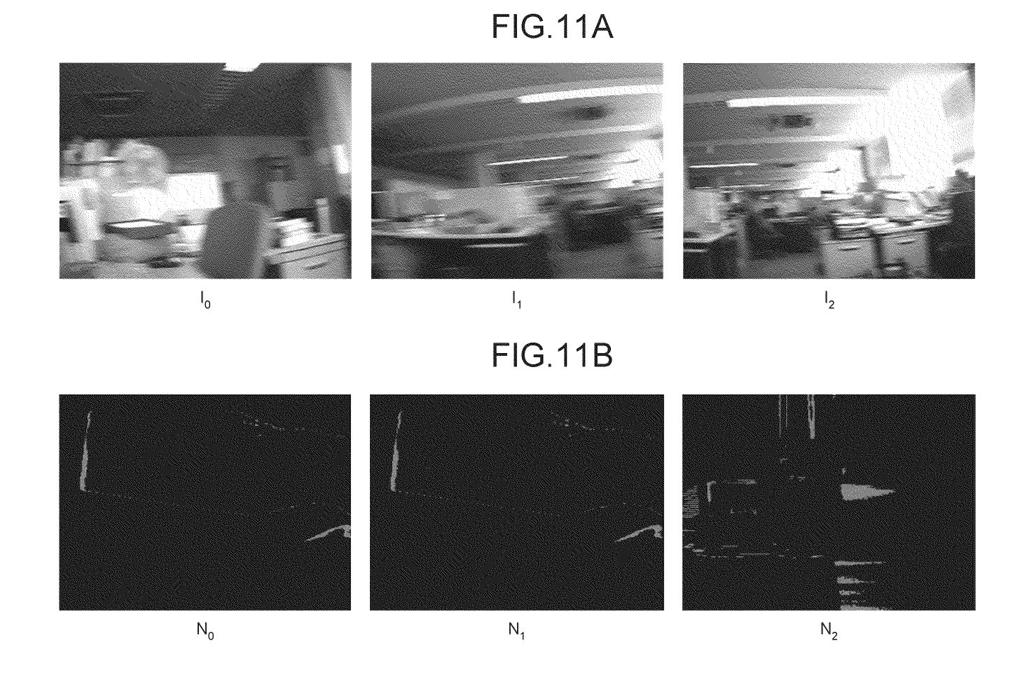

The histogram generating unit 24 then identifies a position at which |Nₘ−Nₘ₋₁| becomes maximum, and divides the captured image range W on the basis of the previous time at which Nₘ is taken. FIGS. 11A and 11B illustrate the images I₀, I₁ and I₂ and images representing the numbers N₀, N₁ and N₂ of object candidate pixels of the respective images I₀, I₁ and I₂ according to the modification. In FIG. 11B, object candidate pixels and pixels that are not object candidate pixels (pixels representing the background) are distinguished from each other using different colors of pixels in order to present the numbers N₀, N₁ and N₂ of object candidate pixels. For example, the object candidate pixels are represented by pixels of low density not in black. In the example illustrated in FIGS. 11A and 11B, the position at which |Nₘ−Nₘ₋₁| becomes maximum is between N₁ and N₂ (the position or the time corresponding to between I₁ and I₂).

The histogram generating unit 24 does not perform division of the captured image range W when the maximum value of |Nₘ−Nₘ₋₁| is smaller than a predetermined threshold. The histogram generating unit 24 may also be configured to repeat division of the captured image range W until all of |Nₘ−Nₘ₋₁| become smaller than the predetermined threshold.

While an example of a case in which the determining unit 28 determines whether each pixel of each second region of a target image for detection is a pixel representing a background or an object candidate pixel to be detected has been described in the embodiment described above, the object detecting apparatus 1 is not limited thereto. For example, the object detecting apparatus 1 may be configured such that the determining unit 28 generates a histogram of pixel values for each second region, determines whether or not a histogram of a first region and a histogram of a corresponding second region are different, and determines that an object to be detected is present if the number of second regions determined to be different is a predetermined number or larger.

As described above, since the object detecting apparatus according to the embodiment determines whether or not an object to be detected is present on the basis of the difference between the frequency of a histogram of pixel values generated for each of a plurality of first regions each extending in the direction of blurring caused by movement and the frequency of pixel values of each second region corresponding to each first region, it is possible to detect whether an object to be detected is present from a blurred image obtained by image capturing during movement.

Meanwhile, the object detecting apparatus described above can also be put into practice with the use of a general-purpose computer device that serves as the basic hardware. That is, the image-capturing position detecting unit 14, the drive control unit 16, the image acquiring unit 20, the position information acquiring unit 22, the histogram generating unit 24, the storage unit 26, the determining unit 28 and the output unit 30 can be implemented by running computer programs in a processor installed in the computer device. At that time, the object detecting apparatus can be put into practice by installing in advance the computer programs in the computer device. Alternatively, the position estimation device can be put into practice by storing the computer programs in a memory medium such as a compact disk read only memory (CD-ROM) or by distributing the computer programs via a network as a computer program product, and then appropriately installing the computer programs in the computer device. Moreover, the image-capturing position detecting unit 14, the drive control unit 16, the image acquiring unit 20, the position information acquiring unit 22, the histogram generating unit 24, the storage unit 26, the determining unit 28 and the output unit 30 can be implemented with the use of a memory medium such as a memory that is embedded in the computer device or attached to the computer device from outside; a hard disk; a compact disk recordable (CD-R), a compact disk rewritable (CD-RW), a digital versatile disk random access memory (DVD-RAM), and a digital versatile disk recordable (DVD-R).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An object detecting apparatus comprising:
an image acquiring unit configured to acquire at least one target image for detection, the target image being captured within a second image capturing range included in a predetermined first image capturing range; and
a determining unit configured to determine whether or not an object that is not captured in at least one reference image is captured in the target image, on the basis of a difference between each frequency of pixel values in a histogram for a first region and each frequency of pixel values in a second region of the target image corresponding to the first region, the first region being one of a plurality of regions each extending in a direction of blurring caused by movement in the reference image, the reference image being captured within the first image capturing range.

2. The apparatus according to claim 1, wherein the determining unit determines a pixel of the second region having a pixel value whose frequency in the histogram is smaller than a predetermined first threshold to be an object candidate pixel that is a candidate of a pixel representing the object, and determines that the object is present when the frequency of the pixel value of the object candidate pixel is a predetermined second threshold or greater.

3. The apparatus according to claim 1, wherein the determining unit generates a histogram of pixel values for each second region, determines whether or not the histogram for the second region and the histogram for the first region corresponding to the second region are different from each other, and determines that the object is present when a number of second regions determined to be different is a predetermined number or greater.

4. The apparatus according to claim 1, further comprising a histogram generating unit configured to generate the histogram of pixel values for each first region, wherein
the determining unit determines whether or not the object is present on the basis of a difference between a frequency in the histogram generated by the histogram generating unit and a frequency of pixel values of each second region.

5. The apparatus according to claim 4, further comprising:
a image capturing unit configured to capture the reference image and the target image;
a drive unit configured to drive the image capturing unit to allow the image capturing unit to move in the first image capturing range for image capturing;
an image-capturing position detecting unit configured to detect position information representing an image-capturing position of the image capturing unit in the first image capturing range; and
a drive control unit configured to control the drive unit so that an image-capturing position of the reference image is associated with an image-capturing position of the target image on the basis of position information detected by the image-capturing position detecting unit.

6. The apparatus according to claim 5, wherein
the image capturing unit captures a plurality of reference images within the first image capturing range, and
the histogram generating unit determines a pixel of the first region having a pixel value whose frequency in the histogram is smaller than a predetermined first threshold to be an object candidate pixel that is a candidate of a pixel representing the object, for each first region of the reference images, divides the reference images into two at the time when a difference between the frequency of the pixel value of the object candidate pixel and a frequency of the pixel value of a pixel determined to be the object candidate pixel in another consecutive reference image captured by the image capturing unit is maximum, and generates a new histogram of pixel values for each first region for each of the two reference images.

7. An object detecting method comprising:
acquiring at least one target image for detection, the target image being captured within a second image capturing range included in a predetermined first image capturing range; and
determining whether or not an object that is not captured in at least one reference image is captured in the target image, on the basis of a difference between each frequency of pixel values in a histogram for a first region and each frequency of pixel values in a second region of the target image corresponding to the first region, the first region being one of a plurality of regions each extending in a direction of blurring caused by movement in the reference image, the reference image being captured within the first image capturing range.

8. A computer-readable medium containing a program executed by a computer, the program causing the computer to execute:
acquiring at least one target image for detection, the target image being captured within a second image capturing range included in a predetermined first image capturing range; and
determining whether or not an object that is not captured in at least one reference image is captured in the target image, on the basis of a difference between each frequency of pixel values in a histogram for a first region and each frequency of pixel values in a second region of the target image corresponding to the first region, the first region being one of a plurality of regions each extending in a direction of blurring caused by movement in the reference image, the reference image being captured within the first image capturing range.
